(19) United States
(12) Patent Application Publication
(10) Pub. No.: US 2023/0084975 A1
(43) Pub. Date: Mar. 16, 2023

(54) OBJECT ORIENTATION IDENTIFICATION METHOD AND OBJECT ORIENTATION IDENTIFICATION DEVICE

(71) Applicant: PEGATRON CORPORATION, TAIPEI CITY (TW)

(72) Inventors: Ming-Jen Chang, Taipei City (TW); Yu-Hung Tseng, Taipei City (TW); Ta-Wei Liu, Taipei City (TW)

(73) Assignee: PEGATRON CORPORATION, TAIPEI CITY (TW)

(21) Appl. No.: 17/871,840

(22) Filed: Jul. 22, 2022

(30) Foreign Application Priority Data
Sep. 14, 2021 (TW) 110134152

(51) Int. Cl. G01S 5/02; G01S 13/87; G06K 9/62

(52) U.S. Cl. CPC G01S 5/02; G01S 13/878; G06K 9/6268

(57) ABSTRACT

An object orientation identification method and an object orientation identification device are provided. The method is adapted for the object orientation identification device including a wireless signal transceiver. The object orientation identification device and a target object are both in a moving state. The method includes the following. A first signal is continuously transmitted by the wireless signal transceiver. A second signal reflected back from the target object is received by the wireless signal transceiver. Signal pre-processing is performed on the first signal and the second signal to obtain moving information of the target object with respect to the object orientation identification device. The moving information is input into a deep learning model to obtain orientation information of the target object with respect to the object orientation identification device. A relative orientation between the object orientation identification device and the target object is identified according to the orientation information.

### CROSS-REFERENCE TO RELATED APPLICATION

This application claims the priority benefit of Taiwanese application no. 110134152, filed on Sep. 14, 2021. The entirety of the above-mentioned patent application is hereby incorporated by reference herein and made a part of this specification.

### BACKGROUND

### Technical Field

The disclosure relates to an object orientation identification method and an object orientation identification device.

### Description of Related Art

It is increasingly popular to use a radar device to measure a distance between the radar device and an obstacle. For example, the radar device transmits a wireless signal to the obstacle and receives the wireless signal reflected back from the obstacle. Then, the distance between the radar device and the obstacle may be estimated by calculating a flight time of the wireless signal between the radar device and the obstacle. However, in identification of an orientation of the obstacle, when the radar device and the obstacle are both in a moving state, in which the moving state of the obstacle is different from the moving state of the radar device, how to accurately identify a relative orientation between them (for example, to identify that the moving obstacle is currently located at an angle of 30 degrees to the front right of the radar device) using the radar device is actually one of issues worked on by researchers in related technical fields.

### SUMMARY

The disclosure provides an object orientation identification method and an object orientation identification device, which can effectively identify a relative orientation between an object orientation identification device and a target object that are both in a moving state.

An embodiment of the disclosure provides an object orientation identification method adapted for an object orientation identification device. The object orientation identification device includes a wireless signal transceiver. The object orientation identification device and a target object are both in a moving state. The object orientation identification method includes the following. A first signal is continuously transmitted by the wireless signal transceiver. A second signal reflected back from the target object is received by the wireless signal transceiver. Signal pre-processing is performed on the first signal and the second signal to obtain moving information of the target object with respect to the object orientation identification device. The moving information is input into a deep learning model to obtain orientation information of the target object with respect to the object orientation identification device. A relative orientation between the object orientation identification device and the target object is identified according to the orientation information.

An embodiment of the disclosure provides an object orientation identification device configured to identify a relative orientation between the object orientation identification device and a target object. The object orientation identification device and the target object are both in a moving state. The object orientation identification device includes a wireless signal transceiver and a processor. The wireless signal transceiver is configured to continuously transmit a first signal and receive a second signal reflected back from the target object. The processor is coupled to the wireless signal transceiver. The processor is configured to perform signal pre-processing on the first signal and the second signal to obtain moving information of the target object with respect to the object orientation identification device; input the moving information into a deep learning model to obtain orientation information of the target object with respect to the object orientation identification device; and identify the relative orientation between the object orientation identification device and the target object according to the orientation information.

Based on the foregoing, even if the object orientation identification device includes a single wireless signal transceiver, the object orientation identification device can still effectively identify the relative orientation between the object orientation identification device and the target object that are both in a moving state.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an object orientation identification device according to an embodiment of the disclosure.

FIG. 2 is a schematic diagram of measuring a distance between an object orientation identification device and a target object according to an embodiment of the disclosure.

FIG. 3 is a schematic diagram of predicting a distance between an object orientation identification device and a target object according to an embodiment of the disclosure.

FIG. 4 is a schematic diagram of positioning a target object according to an embodiment of the disclosure.

FIG. 5 is a schematic diagram of identifying a relative orientation between an object orientation identification device and a target object according to an embodiment of the disclosure.

FIG. 6 is a flowchart of an object orientation identification method according to an embodiment of the disclosure.

### DESCRIPTION OF THE EMBODIMENTS

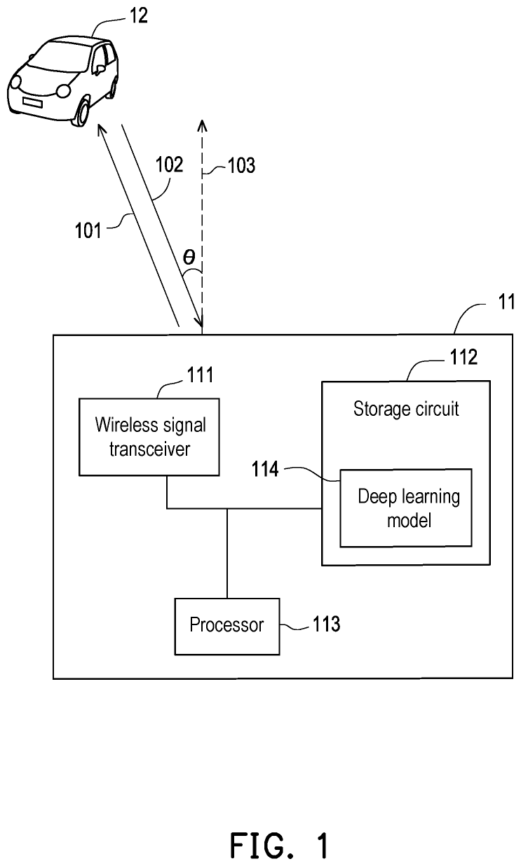

FIG. 1 is a schematic diagram of an object orientation identification device according to an embodiment of the disclosure. With reference to FIG. 1, in an embodiment, an object orientation identification device 11 may be disposed on any vehicles, for example, bicycle, motorcycle, car, motorbus, or truck. The object orientation identification device 11 may be disposed on various forms of portable electronic devices, for example, a smart phone or a head-mounted display. In an embodiment, the object orientation identification device 11 may be disposed on a dedicated object orientation measurement device.

When the object orientation identification device 11 and a target object 12 are both in a moving state (i.e., both the object orientation identification device 11 and the target object 12 are not stationary), the object orientation identification device 11 continuously transmits a wireless signal (also referred to as a first signal) 101 to the target object 12 and receives a wireless signal (also referred to as a second signal) 102 reflected back from the target object 12. For example, the wireless signal 102 may be used to indicate the wireless signal 101 reflected back from the target object 12. The object orientation identification device 11 may identify a relative orientation between the object orientation identification device 11 and the target object 12 that are both in a moving state according to the wireless signals 101 and 102. For example, the relative orientation may be indicated by an angle Θ between a direction the object orientation identification device 11 takes in relation to the target object 12 and a direction 103. For example, the direction 103 may be a direction of the normal vector (i.e., the traveling direction) of the object orientation identification device 11 or any other reference direction that may serve as a direction evaluation criterion.

In an embodiment, the object orientation identification device 11 includes a wireless signal transceiver 111, a storage circuit 112, and a processor 113. The wireless signal transceiver 111 may be configured to transmit the wireless signal 101 and receive the wireless signal 102. For example, the wireless signal transceiver 111 may include a transceiver circuit of wireless signals such as an antenna element and a radio frequency front-end circuit. In an embodiment, the wireless signal transceiver 111 may include a radar device, for example, a millimeter wave radar device, and the wireless signal 101 (and the wireless signal 102) may include a continuous radar wave signal. In an embodiment, the waveform change or the waveform difference between the wireless signals 101 and 102 may reflect a distance between the object orientation identification device 11 and the target object 12.

The storage circuit 112 is configured to store data. For example, the storage circuit 112 may include a volatile storage circuit and a non-volatile storage circuit. The volatile storage circuit is configured to store data in a volatile manner. For example, the volatile storage circuit may include random access memory (RAM) or similar volatile storage media. The non-volatile storage circuit is configured to store data in a non-volatile manner. For example, the non-volatile storage circuit may include read only memory (ROM), a solid state disk (SSD), and/or a hard disk drive (HDD) or similar non-volatile storage media.

The processor 113 is coupled to the wireless signal transceiver 111 and the storage circuit 112. The processor 13 is configured to be responsible for the entirety or part of operations of the object orientation identification device 11. For example, the processor 113 may include a central processing unit (CPU), a graphics processing unit (GPU), or any other programmable general-purpose or special-purpose microprocessor, digital signal processor (DSP), programmable controller, application specific integrated circuit (ASIC), programmable logic device (PLD), or any other similar device or a combination of these devices.

In an embodiment, the object orientation identification device 11 may also include various forms of electronic circuits, for example, a global positioning system (GPS) device, a network interface card, and a power supply. For example, the GPS device is configured to provide information of a position of the object orientation identification device 11. The network interface card is configured to connect the object orientation identification device 11 to the Internet. The power supply is configured to supply power to the object orientation identification device 11.

In an embodiment, the storage circuit 112 may be configured to store a deep learning model 114. The deep learning model 114 is also referred to as an artificial intelligence (AI) model or a neural network model. In an embodiment, the deep learning model 114 is stored in the storage circuit 112 in the form of a software module. However, in another embodiment, the deep learning model 114 may also be implemented as a hardware circuit, which is not limited by the disclosure. The deep learning model 114 may be trained to improve prediction accuracy for specific information. For example, a training data set may be input into the deep learning model 114 during the training phase of the deep learning model 114. The decision logic (e.g., algorithm rules and/or weight parameters) of the deep learning model 114 may be adjusted according to the output of the deep learning model 114 to improve the prediction accuracy of the deep learning model 114 for specific information.

In an embodiment, it is assumed that the object orientation identification device 11 is currently in a moving state (also known as a first moving state) and the target object 12 is currently also in a moving state (also known as a second moving state). Note that the first moving state may be different from the second moving state. For example, a moving direction of the object orientation identification device 11 in the physical space may be different from a moving direction of the target object 12 in the physical space and/or a moving speed of the object orientation identification device 11 in the physical space may be different from a moving speed of the target object 12 in the physical space.

In an embodiment, the object orientation identification device 11 in the first moving state may continuously transmit the wireless signal 101 by the wireless signal transceiver 111 and continuously receive the wireless signal 102 by the wireless signal transceiver 111.

In an embodiment, the processor 113 may perform signal pre-processing on the wireless signals 101 and 102 to obtain moving information of the target object 12 with respect to the object orientation identification device 11. For example, the processor 113 may perform signal processing operations such as Fourier transform on the wireless signals 101 and 102 to obtain the moving information. For example, the Fourier transform may include one-dimensional Fourier transform and/or two-dimensional Fourier transform.

In an embodiment, the moving information may include the distance between the object orientation identification device 11 and the target object 12 and/or a relative moving speed between the object orientation identification device 11 and the target object 12, but is not limited thereto. In an embodiment, the moving information may also include other evaluation information that may be configured for evaluating various forms of physical quantities, for example, the spatial state, the change of the spatial state, and/or the relative moving state, between the object orientation identification device 11 and the target object 12.

In an embodiment, the processor 113 may analyze the moving information using the deep learning model 114. For example, the processor 113 may input the moving information into the deep learning model 114 to obtain orientation information of the target object 12 with respect to the object orientation identification device 11. Then, the processor 113 may identify the relative orientation between the object orientation identification device 11 and the target object 12 (e.g., the angle Θ in FIG. 1) according to the orientation information.

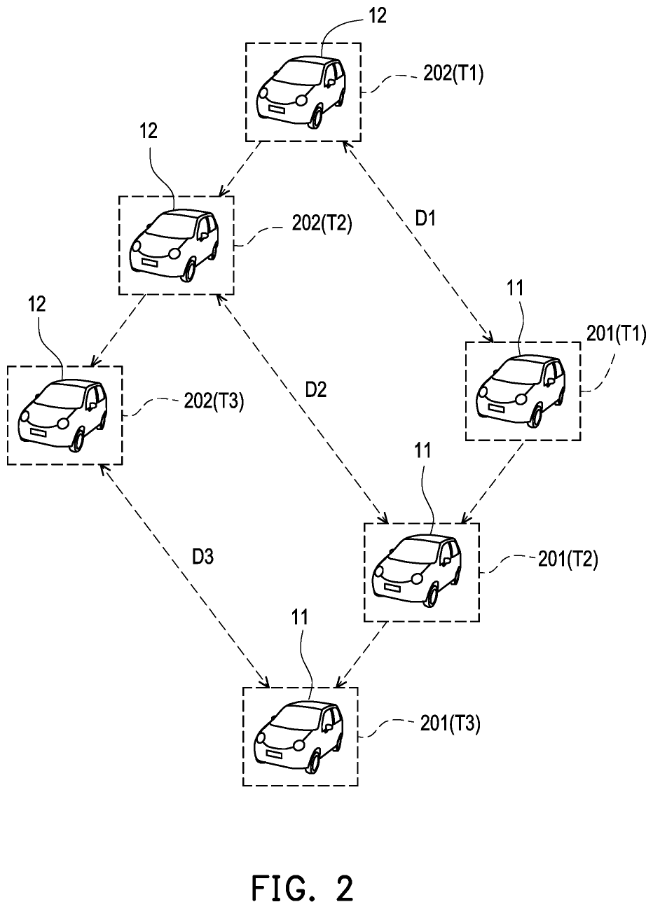

FIG. 2 is a schematic diagram of measuring a distance between an object orientation identification device and a target object according to an embodiment of the disclosure. With reference to FIG. 1 and FIG. 2, it is assumed that the object orientation identification device 11 in the first moving state sequentially moves to positions 201(T1), 201(T2), and 201(T3) at time points T1, T2, and T3 respectively, where the time point T1 is earlier than the time point T2, and the time point T2 is earlier than the time point T3. In addition, the target object 12 in the second moving state sequentially moves to positions 202(T1), 202(T2), and 202(T3) at the time points T1, T2, and T3 respectively. Moreover, during movement of the object orientation identification device 11 and the target object 12 (i.e., from the time point T1 to T3), the object orientation identification device 11 may continuously transmit the wireless signal 101 and receive the wireless signal 102 reflected back from the target object 12.

In an embodiment, the processor 113 may measure distances D1, D2 and D3 according to the wireless signals 101 and 102. The distance D1 is used to indicate a distance between the position 201(T1) and the position 202(T1). The distance D2 is used to indicate a distance between the position 201(T2) and the position 202(T2). The distance D3 is used to indicate a distance between the position 201(T3) and the position 202(T3). In an embodiment, the processor 113 may perform signal pre-processing including one-dimensional Fourier transform on the wireless signals 101 and 102 to obtain the moving information including the distances D1, D2 and D3.

In an embodiment, the position 202(T3) is also referred to as a current position of the target object 12. In an embodiment, the time points T1 and T2 differ by one unit time, and the time points T2 and T3 also differ by one unit time. In other words, the time points T1 and T3 differ by two unit times. One unit time may be one second or any other length of time, which is not limited by the disclosure. In an embodiment, the time point T3 is also referred to as a current time point, the time point T2 is also referred to as a previous-one-unit time point of the time point T3, and the time point T1 is also referred to as a previous-two-unit time point of the time point T3.

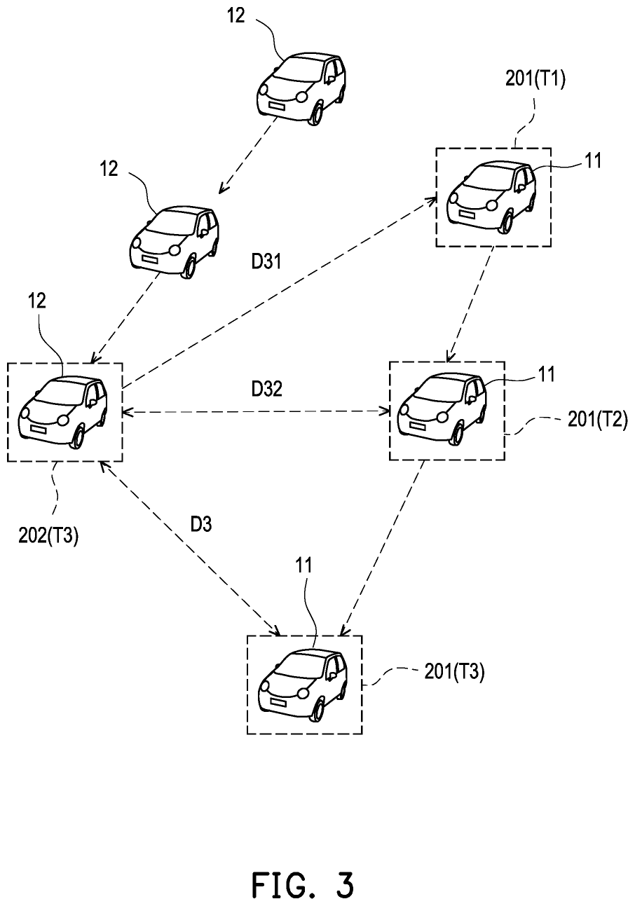

FIG. 3 is a schematic diagram of predicting a distance between an object orientation identification device and a target object according to an embodiment of the disclosure. With reference to FIG. 3, following the embodiment of FIG. 2, the processor 113 may input the moving information including the distances D1, D2 and D3 into the deep learning model 114 for analysis to obtain the orientation information including distances D31 and D32. The distance D31 is used to indicate a distance (also known as a first predicted distance) between the position 201(T1) of the object orientation identification device 11 at the time point (also known as a first time point) T1 and the position 202(T3) of the target object 12 at the time point (also known as a third time point) T3. The distance D32 is used to indicate a distance (also known as a second predicted distance) between the position 201(T2) of the object orientation identification device 11 at the time point (also referred to as a second time point) T2 and the position 202(T3) of the target object 12 at the time point T3.

It should be noted that, the object orientation identification device 11 and the target object 12 are both in a continuously moving state at the time points T1 to T3, and the moving direction and the moving speed of the target object 12 are uncontrollable (or unknown). Therefore, the distances D31 and D32 can be predicted by the deep learning model 114 according to the moving information, but the distances D31 and D32 cannot be measured simply based on the wireless signals 101 and 102 (e.g., the waveform change or the waveform difference between the wireless signals 101 and 102).

In an embodiment, the deep learning model 114 includes a time series-based prediction model such as a long short-term memory model (LSTM). The deep learning model 114 may predict the distances D31 and D32 according to the distances D1, D2 and D3 sequentially corresponding to the time points T1 to T3. To be specific, training data including a large number of known distances D1, D2, D3, D31, and D32 may be input into the deep learning model 114 to train the deep learning model 114 to predict the distances D31 and D32 based on the distances D1, D2 and D3.

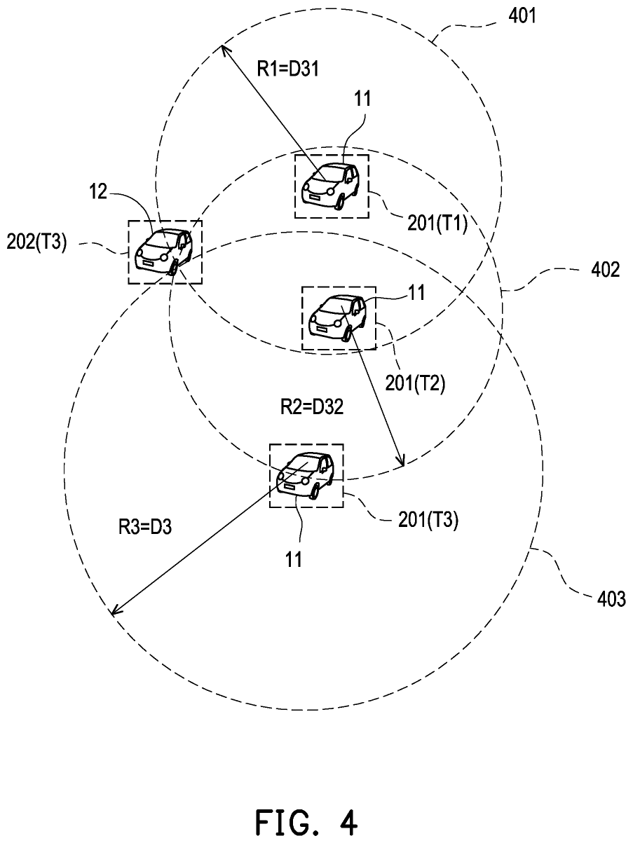

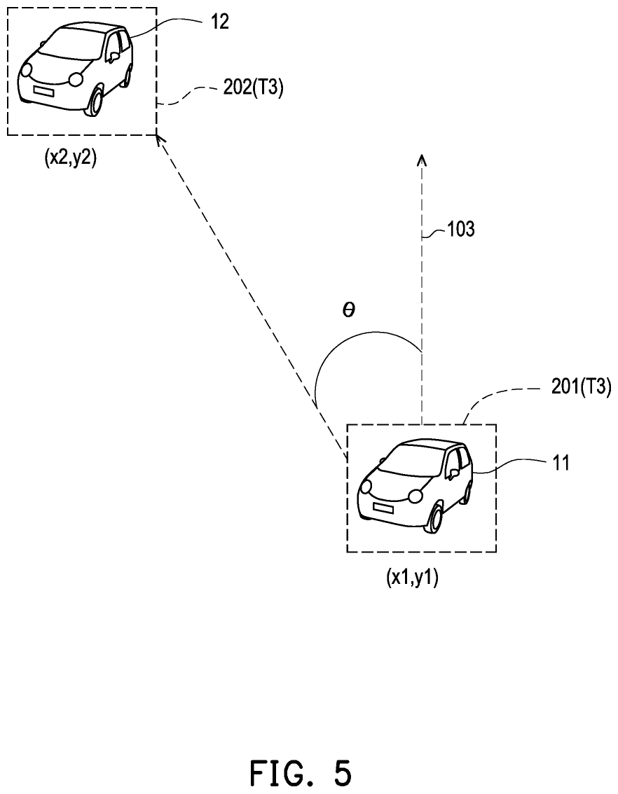

FIG. 4 is a schematic diagram of positioning a target object according to an embodiment of the disclosure. With reference to FIG. 4, following the embodiment of FIG. 3, the processor 113 may determine the position 202(T3) of the target object 12 at the time point T3 according to the predicted distances D31 and D32 and the measured distance D3. Taking triangulation as an example, the processor 113 may simulate a virtual circle 401 with the distance D31 as a radius R1 and the position 201(T1) of the object orientation identification device 11 at the time point T1 as the center, simulate a virtual circle 402 with the distance D32 as a radius R2 and the position 201(T2) of the object orientation identification device 11 at the time point T2 as the center, and simulate a virtual circle 403 with the distance D3 as a radius R3 and the position 201(T3) of the object orientation identification device 11 at the time point T3 as the center. The processor 113 may determine the position 202(T3) of the target object 12 at the time point T3 according to the intersection or overlap between the circles 401 to 403. For example, the orientation information may include information (e.g., coordinates (x2, y2) of FIG. 5) of the position 202(T3) of the target object 12 at the time point T3 determined by the processor 113.

FIG. 5 is a schematic diagram of identifying a relative orientation between an object orientation identification device and a target object according to an embodiment of the disclosure. With reference to FIG. 5, following the embodiment of FIG. 4, the processor 113 may obtain the relative orientation between the object orientation identification device 11 in the first moving state and the target object 12 in the second moving state at the time point T3 according to the position 201(T3) of the object orientation identification device 11 at the time point T3 and the position 202(T3) of the target object 12 at the time point T3. For example, assuming coordinates of the position 201(T3) are (x1, y1) and coordinates of the position 202(T3) are (x2, y2), then the processor 113 may obtain the angle Θ between a direction 501 and the direction 103 according to the coordinates (x1, y1) and (x2, y2). The direction 501 points from the position 201(T3) to the position 202(T3). The direction 103 is a reference direction (e.g., the direction of the normal vector of the object orientation identification device 11).

In an embodiment, the processor 113 may describe the relative orientation between the object orientation identification device 11 in the first moving state and the target object 12 in the second moving state at the time point T3 based on the angle Θ. For example, the processor 113 may present a message “the target object 12 is Θ degrees to the left in front of the object orientation identification device 11” or the like by text or voices.

In an embodiment, the moving information may also include the relative moving speed between the object orientation identification device 11 and the target object 12. For example, the processor 113 may perform signal pre-processing including two-dimensional Fourier transform on the wireless signals 101 and 102 to obtain the relative moving speed between the object orientation identification device 11 and the target object 12.

In an embodiment, the processor 113 may also add speed measurement information and position measurement information into the moving information. The speed measurement information reflects the moving speed of the object orientation identification device 11 in the first moving state. The position measurement information reflects the measured position of the object orientation identification device 11 in the first moving state. The speed measurement information and the position measurement information may be obtained by at least one sensor disposed in the object orientation identification device 11. For example, the sensor may include a speed sensor, a gyroscope, a magnetic-field sensor, an accelerometer, a GPS device, and the like, which is not limited by the disclosure. The processor 113 may obtain the speed measurement information and the position measurement information according to the sensing result of the sensor.

In an embodiment, the deep learning model 114 may predict the moving trajectory of the target object 12 in the second moving state or the position of the target object 12 in the second moving state at a specific time point (e.g., the time point T3 in FIG. 2) according to the moving information. Taking FIG. 2 as an example, the processor 113 may input the moving information including the moving speeds of the object orientation identification device 11 at the time points T1, T2 and T3 respectively, the positions 201(T1), 201(T2) and 201(T3), the distances D1, D2 and D3, and the relative moving speed between the object orientation identification device 11 and the target object 12 into the deep learning model 114. The deep learning model 114 may output position prediction information according to the moving information. The position prediction information may include the position 202(T3) (e.g., the coordinates (x2, y2) of FIG. 5) of the target object 12 at the time point T3 in the second moving state predicted by the deep learning model 114. Then, the processor 113 may identify the relative orientation between the object orientation identification device 11 in the first moving state and the target object 12 in the second moving state at the time point T3 according to the positions 201(T3) and 202(T3). For example, the processor 113 may obtain the angle Θ between the directions 501 and 103 according to the coordinates (x1, y1) of the position 201(T3) and the coordinates (x2, y2) of the position 202(T3) in FIG. 5. Detailed description of the relevant operation details has been provided above, and will not be repeated here.

In an embodiment, during the training phase, the processor 113 may input a training data set into the deep learning model 114 to train the deep learning model 114. In an embodiment, the training data set may include distance data and verification data. The processor 113 may verify at least one predicted distance output by the deep learning model 114 in response to the distance data in the training data set according to the verification data. Then, the processor 113 may adjust the decision logic of the deep learning model 114 according to the verification result. For example, the distance data may include the distances D1, D2 and D3 between the object orientation identification device 11 and the target object 12 respectively at the time points T1 to T3 in FIG. 3. For example, the predicted distance may include a predicted value of the distance D31 and/or the distance D32 in FIG. 3, and the verification data may include a correct value of the distance D31 and/or the distance D32. The processor 113 may adjust the decision logic of the deep learning model 114 according to the difference between the predicted value of the distance output by the deep learning model 114 and the correct value. Accordingly, it is possible to improve the future prediction accuracy of the deep learning model 114 for the distance between the object orientation identification device 11 and the target object 12.

In an embodiment, the training data set may include distance data, speed data, and verification data. The processor 113 may verify at least one predicted position output by the deep learning model 114 in response to the distance data and the speed data in the training data set according to the verification data. Then, the processor 113 may adjust the decision logic of the deep learning model 114 according to the verification result. For example, the distance data may include the distances between the object orientation identification device 11 and the target object 12 at a plurality of time points, and the speed data may include the moving speeds of the object orientation identification device 11 at the plurality of time points, the positions of the object orientation identification device 11 at the plurality of time points, and the relative moving speeds between the object orientation identification device 11 and the target object 12 at the plurality of time points. Furthermore, the predicted position may include a predicted value of the position (e.g., the coordinates (x2, y2) of FIG. 5) of the target object 12 at a specific time point, and the verification data may include a correct value of the position of the target object 12 at the specific time point. The processor 113 may adjust the decision logic of the deep learning model 114 according to the difference between the predicted value of the position output by the deep learning model 114 and the correct value of the position. Accordingly, it is possible to improve the future prediction accuracy of the deep learning model 114 for the position (e.g., the position 202(T3) of FIG. 5) of the target object 12 at the specific time point in the future.

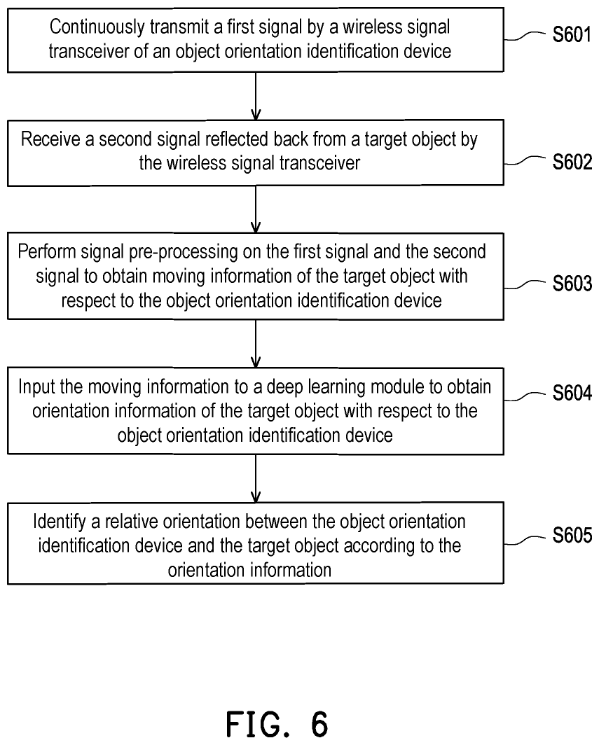

FIG. 6 is a flowchart of an object orientation identification method according to an embodiment of the disclosure. With reference to FIG. 6, in step S601, a first wireless signal is continuously transmitted by a wireless signal transceiver in an object orientation identification device. In step S602, a second wireless signal reflected back from a target object is received by the wireless signal transceiver. In step S603, signal pre-processing is performed on the first signal and the second signal to obtain moving information of the target object with respect to the object orientation identification device. In step S604, the moving information is input into a deep learning model to obtain orientation information of the target object with respect to the object orientation identification device. In step S605, a relative orientation between the object orientation identification device and the target object is identified according to the orientation information.

Detailed description of each step in FIG. 6 has been provided above, and will not be repeated here. Each step in FIG. 6 may be implemented as a plurality of programming codes or circuits, which is not limited by the disclosure. In addition, the method of FIG. 6 may be used with the exemplary embodiments above, and may also be used alone, which is not limited by the disclosure.

In summary of the foregoing, according to the embodiments of the disclosure, the relative orientation between the object orientation identification device and the target object that are in different moving states may be identified by the wireless signal transceiver and the deep learning model. Accordingly, it is possible to effectively improve the convenience in using the object orientation identification device and the detection accuracy for the relative orientation between the object orientation identification device and the target object.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An object orientation identification method adapted for an object orientation identification device comprising a wireless signal transceiver, wherein the object orientation identification device and a target object are both in a moving state, and the object orientation identification method comprises:
continuously transmitting a first signal by the wireless signal transceiver;
receiving a second signal reflected back from the target object by the wireless signal transceiver;
performing signal pre-processing on the first signal and the second signal to obtain moving information of the target object with respect to the object orientation identification device;
inputting the moving information into a deep learning model to obtain orientation information of the target object with respect to the object orientation identification device; and
identifying a relative orientation between the object orientation identification device and the target object according to the orientation information.

2. The object orientation identification method according to claim 1, wherein the moving information comprises a distance between the object orientation identification device and the target object at a same time point during movement.

3. The object orientation identification method according to claim 2, wherein a step of performing the signal pre-processing on the first signal and the second signal to obtain the moving information comprises:
performing one-dimensional Fourier transform on the first signal and the second signal to obtain the distance.

4. The object orientation identification method according to claim 2, wherein the orientation information comprises a plurality of predicted distances between a position of the target object at a current time point predicted by the deep learning model and positions of the object orientation identification device at a previous-one-unit time point and a previous-two-unit time point.

5. The object orientation identification method according to claim 4, wherein a step of identifying the relative orientation between the object orientation identification device and the target object according to the orientation information comprises:
identifying the relative orientation between the object orientation identification device and the target object based on the distance between the position of the target object at the current time point and a position of the object orientation identification device at the current time point and based on the predicted distances.

6. The object orientation identification method according to claim 2, wherein the moving information further comprises a relative moving speed between the object orientation identification device and the target object.

7. The object orientation identification method according to claim 6, wherein a step of performing the signal pre-processing on the first signal and the second signal to obtain the moving information comprises:
performing two-dimensional Fourier transform on the first signal and the second signal to obtain the relative moving speed.

8. The object orientation identification method according to claim 6, wherein the orientation information comprises a position of the target object at a current time point predicted by the deep learning model.

9. The object orientation identification method according to claim 1, wherein the deep learning model comprises a long short-term memory model.

10. An object orientation identification device configured to identify a relative orientation between the object orientation identification device and a target object, wherein the object orientation identification device and the target object are both in a moving state, and the object orientation identification device comprises:
a wireless signal transceiver configured to continuously transmit a first signal and receive a second signal reflected back from the target object; and
a processor coupled to the wireless signal transceiver and configured to:
perform signal pre-processing on the first signal and the second signal to obtain moving information of the target object with respect to the object orientation identification device;
input the moving information into a deep learning model to obtain orientation information of the target object with respect to the object orientation identification device; and
identify the relative orientation between the object orientation identification device and the target object according to the orientation information.

11. The object orientation identification device according to claim 10, wherein the moving information comprises a distance between the object orientation identification device and the target object at a same time point during movement.

12. The object orientation identification device according to claim 11, wherein an operation of performing the signal pre-processing on the first signal and the second signal to obtain the moving information comprises:
performing one-dimensional Fourier transform on the first signal and the second signal to obtain the distance.

13. The object orientation identification device according to claim 11, wherein the orientation information comprises a plurality of predicted distances between a position of the target object at a current time point predicted by the deep learning model and positions of the object orientation identification device at a previous-one-unit time point and a previous-two-unit time point.

14. The object orientation identification device according to claim 11, wherein the moving information further comprises a relative moving speed between the object orientation identification device and the target object.

15. The object orientation identification device according to claim 14, wherein an operation of performing the signal pre-processing on the first signal and the second signal to obtain the moving information comprises:
performing two-dimensional Fourier transform on the first signal and the second signal to obtain the relative moving speed in the moving information.

16. The object orientation identification device according to claim 14, wherein the orientation information comprises a position of the target object at a current time point predicted by the deep learning model.
